(19) United States
(12) Patent Application Publication
(10) Pub. No.: US 2007/0055862 A1
(43) Pub. Date: Mar. 8, 2007

(54) METHOD AND SYSTEM FOR DISTRIBUTING DATA

(75) Inventors: Sanjeev K. Sharma, Pottstown, PA (US); Sylvie Gomes, Douglaston, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/470,886

(22) Filed: Sep. 7, 2006

Related U.S. Application Data
(60) Provisional application No. 60/715,243, filed on Sep. 8, 2005.
(60) Provisional application No. 60/749,239, filed on Dec. 9, 2005.

(51) Int. Cl. H04L 9/00

(52) U.S. Cl. 713/150; 709/218

(57) ABSTRACT

A method and system for distributing data to at least one communication device are disclosed. When multiple communication devices request the same data, a seeder sends a different piece of the data to each communication device and the communication devices share the piece of data each other by using a wireless connection established between them. The communication devices automatically suspend and resume downloading of the piece of the data from other communication devices as the communication device performs a handover. The receiver may be given super-distribution rights. When a destination communication device requests data, a content provider identifies a source communication device which possesses the same data and has the source communication device to forward the data to the destination communication device. The source communication device re-encrypts the data with a new encryption key and the destination communication device obtains a license from a rights issuer to decrypt the data.

### CROSS REFERENCE TO RELATED APPLICATION

This application claims the benefit of U.S. Provisional Application Nos. 60/715,243 filed Sep. 8, 2005 and 60/749,239 filed Dec. 9, 2005, which are incorporated by reference as if fully set forth.

### FIELD OF INVENTION

The present invention is related to distribution of data in a communication system. More particularly, the present invention is related to a method and system for distributing data to at least one communication device.

### BACKGROUND

With the advances in memory and storage technology, the available capacity for data storage on a communication device can be considered to be, for all practical purposes, “nearly infinite.” One of the implications of infinite storage on future communication devices is that the communication devices are able to download large files. The large file downloads choke a central server in a simple “client-server” system.

In order to solve the problem of the client-server system, a new data downloading scheme called cooperative distribution has been developed and has been used in the Internet world for file downloading. BitTorrent is one of the peer-to-peer technologies using the cooperative distribution technology, where a file reaches the client via multiple peers, acting as middle-layer servers.

FIG. 1 shows a conventional cooperative distribution system 100 over the Internet. In the example of FIG. 1, three communication devices 102a, 102b, 102c need to download the same file from a fourth communication device 102d (seeder). The seeder 102d is a communication device having the complete file available in its storage unit. Each communication device 102a-102c and the seeder 102d have an Internet connection 110a-110d to a central tracker 104. With the help of the central tracker 104, the communication devices 102a-102c establish Internet connections 106a, 106b with the seeder 102d and Internet connections 108a, 108b, 108c among the communication devices 102a-102c. All the communication devices 102a-102c receive different pieces of the file from the seeder 102d, respectively. The communication devices 102a-102c then share the downloaded pieces of the file by uploading to each other via the Internet connections 108a-108c between them using their own upload bandwidths. Thus, the communication devices 102a-102c get the full file, while the seeder 102d is only loaded to a part of its upload bandwidth.

The conventional wired cooperative distribution has been expanded to wireless cooperative distribution. However, the conventional wireless cooperative distribution scheme is applied to architecturally static device-to-device communication over the Internet in a static sense. In the conventional wireless cooperative distribution scheme, the wireless devices form peer-to-peer networks within a venue such as cinemas, theaters, concert halls, or sporting arenas using Wi-Fi technology. Architecturally, it is quite similar to the wired network, except that the last connection is wireless. One of the disadvantages of the conventional cooperative distribution is that it does not address the mobility aspect of the communication devices when the communication devices are handing over across cells or different radio access technologies.

Meanwhile, wireless digital rights management (DRM) provides a protection over a specific content. The DRM provides the protection according to two different models: the user may request to download the protected content from the content provider server, or may receive the protected content from another user if super-distribution is allowed by the content provider.

When super-distribution is allowed, the receiver does not choose the content he/she receives, since it is the sender who takes the initiative to distribute a certain piece of content to other users. The goal of super-distribution is mostly to increase the distribution and sales of the content by providing incentive to consumers to share the content with other consumers.

With infinite storage available on a mobile device, the user is able to store many pieces of content on the mobile device. However, it is time-consuming to download many files from the content provider server, and the content provider server might encounter difficulties fulfilling a large number of download requests at the same time. Moreover, the conventional super-distribution system does not permit the user to choose the content for downloading, and does not assure that the communication device providing the content is located close to a communication device to which the content is destined.

Therefore, it would be desirable to provide a method for distributing data which lifts any mobility constraints on the communication devices engaged in the distribution. It would also be desirable to provide a more efficient and secure distribution method and system when super-distribution is allowed, while permitting the user to select the content before downloading it.

### SUMMARY

The present invention is related to a method and system for distributing data to at least one communication device. When a plurality of communication devices request a download of the same data, a seeder sends a different piece of the data to each of the communication devices and the communication devices send the received piece of the data to other communication devices using a wireless connection established between them. Each of the communication devices automatically suspends and resumes downloading of a piece of the data from other communication devices as the communication device performs a handover.

The receiver may optionally be given a super-distribution right and the data may be protected by DRM. When a destination communication device requests a download of data from a content provider, the content provider identifies a source communication device which possesses the same data and requests the source communication device to forward the data to the destination communication device. The source communication device re-encrypts the data with a new encryption key and the destination communication device obtains a license and a decryption key from a rights issuer and decrypts the re-encrypted data with the decryption key.

### BRIEF DESCRIPTION OF THE DRAWINGS

FIG. 1 shows conventional cooperative distribution over the internet.

FIG. 2 shows an exemplary cooperative distribution system in accordance with the present invention.

FIG. 3 is a block diagram of a communication device used in the system of FIG. 2.

FIG. 4 is a block diagram of an organized super-distribution system in accordance with the present invention.

FIG. 5 is a signaling diagram of a process for distributing data in accordance with the present invention.

FIG. 6 is a block diagram of a communication device used in the system of FIG. 4.

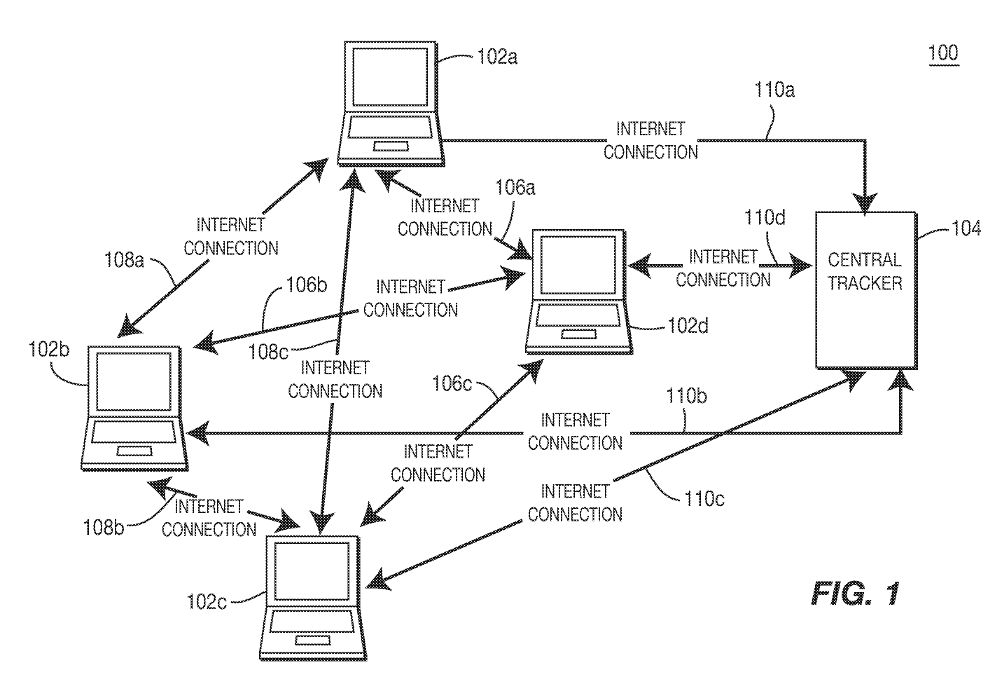

### DETAILED DESCRIPTION OF THE PREFERRED EMBODIMENTS

When referred to hereafter, the terminology “communication device” includes but is not limited to a wireless transmit/receive unit (WTRU), a user equipment, a mobile station, a fixed or mobile subscriber unit, a pager, a notebook computer, a palmtop computer, a personal data assistant (PDA), or any other type of device capable of operating in a wireless or wired communication system. When referred to hereafter, the terminology “base station” includes but is not limited to a Node-B, a site controller, an access point or any other type of interfacing device in a wireless environment.

The features of the present invention may be incorporated into an integrated circuit (IC) or be configured in a circuit comprising a multitude of interconnecting components.

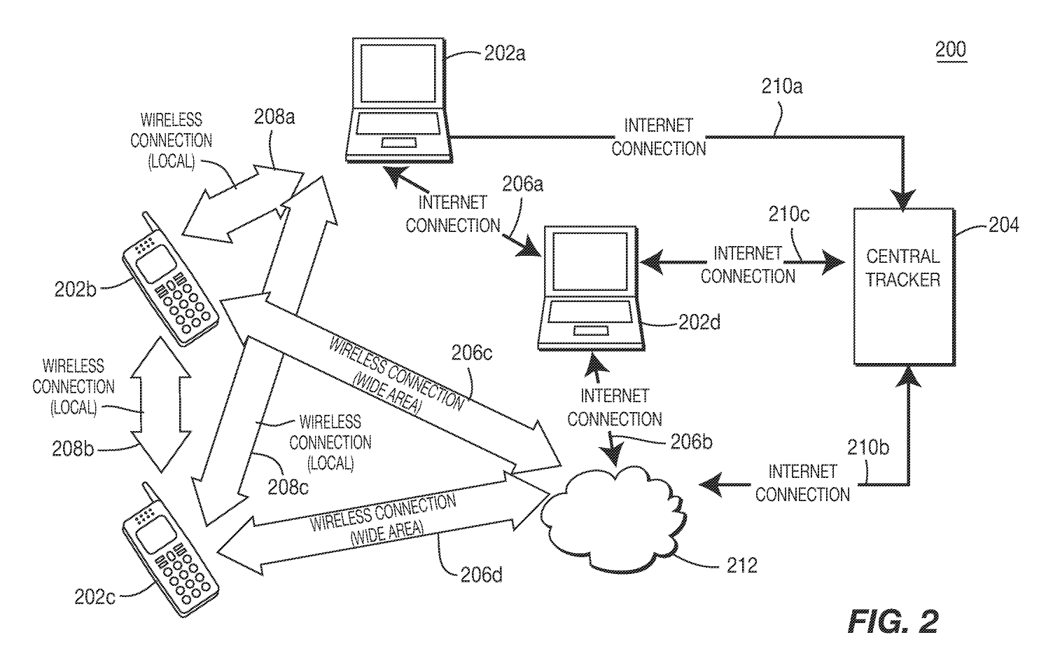

In accordance with a first embodiment of the present invention, cooperative distribution is employed by communication devices without placing any mobility constraint thereon. FIG. 2 shows an exemplary cooperative distribution system 200 in accordance with the present invention. The system 200 includes a plurality of communication devices 202a, 202b, 202c, a seeder 202d and a central tracker 204. In FIG. 2, three communication devices 202a-202c, a lap-top computer 202a and cellular phones 202b, 202c, are illustrated. It should be noted that the communication devices 202a-202c may be any type of communication devices and any number of communication devices may be included in the system 200.

The communication devices 202a-202c want to download the same file. The communication devices 202a-202c establish Internet connections 210a, 210b+206c and 210b+206d with the central tracker 204 and send a request for download of the file to the central tracker 204. The central tracker 204 identifies a fourth communication device 202d, (i.e., the seeder), which possesses the data. With the help of the central tracker 204, each of the communication devices 202a-202c establishes a connection 206a, 206b+206c, and 206b+206d, (e.g., an Internet connection), with the seeder 202d, respectively. The communication devices 202a-202c also establish wireless connections 208a-208c with each other. The wireless connections 208a-208c between the communication devices 202a-202c may be established via a radio access network (RAN) 212. The RAN 212 may be a wireless local area network (WLAN), (an ad-hoc WLAN or an infrastructure mode WLAN, such as IEEE 802-based network), or a wide area cellular network, (such as universal mobile telecommunication services (UMTS) terrestrial radio access network (UTRAN)). The RAN 212 includes a handover entity and a mobile positioning entity (not shown) for supporting handover of the communication devices 202a-202c.

The seeder 202d sends a different piece of the file to each communication device 202a-202c. Each of the communication devices 202a-202c receive a different piece of the file. The communication devices 202a-202c then share each downloaded piece of the file by uploading to each other via the connections 208a-208c between the communication devices 202a-202c using their own upload bandwidths.

As the communication devices 202a-202c roam around different geographic areas which may be covered by different radio access technologies, the connections 208a-208c between the communication devices 202a-202c may need to be reestablished.

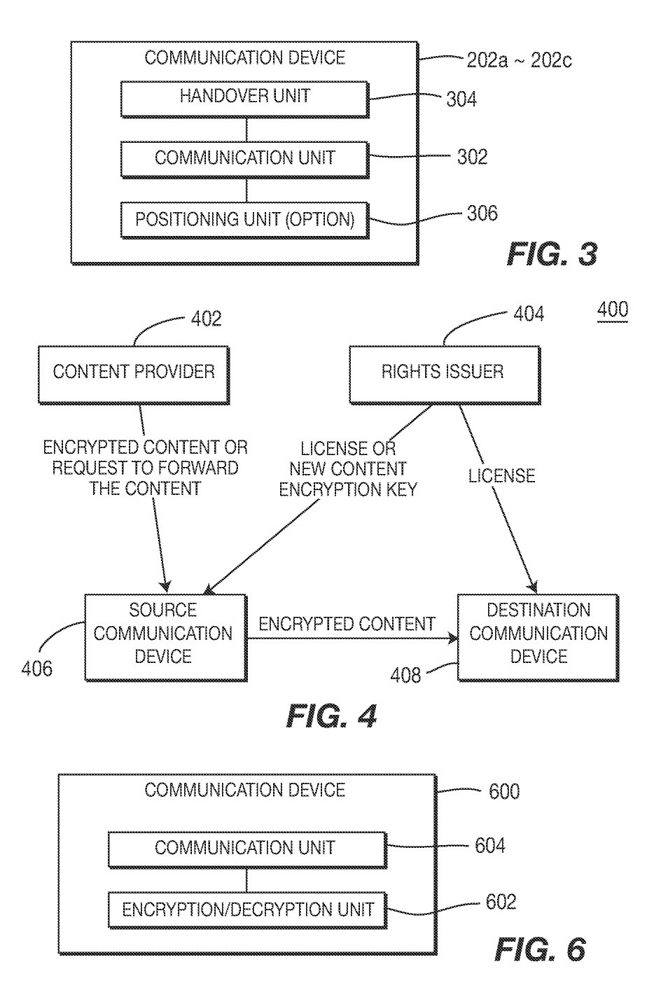

FIG. 3 is a block diagram of a communication device 202a-202c in the system 200 of FIG. 2. Each communication device 202a-202c includes a communication unit 302 and a handover unit 304, and may include a positioning unit 306 (optional). The communication unit 302 establishes connections to the seeder 202d and other communication devices 202a-202c, respectively, to send and receive data to and from the seeder 202d and other communication devices 202a-202c, respectively. The handover unit 304 controls a handover between different cells/sectors or different radio access technologies based on handover events and requirements. The communication unit 302 interacts with the handover unit 304 and automatically suspends and resumes downloading of a piece of the data from other communication devices 202a-202c when a handover is performed.

When a handover takes place, a destination communication device may lose downlink data from source communication devices during the temporary connection break for the handover, unless the source communication devices are asked to pause the transmission temporarily. In the context of multiple simultaneous download connections, the temporary connection break may lead to wasteful upload activity. Prior art techniques, for example, BitTorrent, support automatic resuming of file downloads after temporary suspensions or connection breaks. However, a download application in the destination communication device is not aware of the reason behind the connection break, causing it to possibly discard some of the incomplete file pieces and continuously try to reconnect. The present invention solves these problems of wasted upload activity and wasteful reconnection attempts with selective communications between the handover unit 304 and the communication unit 302.

When a handover takes place, the handover unit 304 of a destination communication device, (such as communication device 202b), informs its communication unit 302 of the initiation of the handover and the imminent pause of downloading. At the same time, the handover entity (not shown in FIG. 2) in the RAN 212 through which the communication device 202b establishes a connection to the seeder 202d may interact with the central tracker 204, which in turn may pause the upload activity at other source communication devices, (such as communication devices 202a, 202c). When the handover is complete, the handover unit 304 of the destination communication device 202b informs the communication unit 302 of the completion of the handover, and the central tracker 204 also informs the completion of the handover to the communication devices 202a, 202c. The download activity at the destination communication device 202b and the upload activity at the source communication devices 202a, 202c are then resumed. The destination communication device 202b may optionally exchange information with the central tracker 204 regarding the exact location where the download paused, so that the downloading may be resumed from the same location without discarding incomplete pieces of the data.

The communication device 202a-202c may optionally include the positioning unit 306 to determine the location of other communication devices 202a-202c and/or the central tracker 204. If the communication device 202a-202c has knowledge of the geographic location of, (or distance to), other communication devices 202a-202c, the communication device 202a-202c may establish a short range connection, (e.g., via a WLAN or ad hoc connection), instead of establishing a connection via a wide area cellular network. This helps to achieve a low network latency and reduce network congestions in the cellular network. The positioning unit 306 may obtain the location information using at least one of a global positioning system (GPS), a triangulation method and information regarding a cell with which the communication devices are associated.

As a communication device 202a-202c roams, the geographical distance and channel conditions between the communication devices 202a-202c change. Therefore, the previous preferred short range connection(s) may no longer be supported or preferred and the communication unit 302 reestablishes a connection to other communication devices 202a-202c based on the location information.

The handover unit 304 may perform an inter-radio access technology handover, (e.g. cellular to WLAN, or vice versa). The communication unit 302 reestablishes the connections with other communication devices 202a-202c using different radio access technologies based on the handover event and the location information.

The central tracker 204 may proactively listen and respond to the handover events and requirements of the communication devices 202a-202c. The communication devices 202a-202c report their own handover events or requirements and/or location information to the central tracker 204 and the central tracker 204 may combine these events and information collected from the communication devices 202a-202c with the knowledge of other communication devices' presence in the system 200 and provide a new optimized connection list back to the communication devices 202a-202c.

The central tracker 204 may be closely tied with the handover entity and the mobile positioning entity residing in the RAN 212 to make use of the information obtained from the RAN 212. In other words, the central tracker 204 may influence the handover decisions made by the RAN 212 in order to optimize the cooperative distribution connections. For example, the central tracker 204 may initiate the handover to keep the connections optimized. The central tracker 204 may also pick one handover option over the other when multiple handover options exist, (e.g., handover between multiple radio access technologies). This is particularly useful if the central tracker 204 is implemented by a service provider itself because the service provider can easily define a new interface between the handover and positioning entities at the RAN 212 and the central tracker 204.

It should be noted that the seeder 202d, the central tracker 204 or the communication devices 202a-202c may be the same entity or may be included in various entities. For example, the central tracker 204 may be included in a service provider server. The communication devices 202a-202c may be configured to perform the functions of the central tracker 204 or the seeder 202d. Additionally, a base station or a radio network controller of the RAN 212 may be configured to perform the functions of the central tracker 204 or the seeder 202d.

In accordance with a second embodiment of the present invention, an organized super-distribution system 400 is provided. FIG. 4 is a block diagram of an organized super-distribution system 400 in accordance with the present invention. The system 400 includes a content provider 402, a rights issuer 404, a source communication device 406 and at least one destination communication device 408. The content provider 402 provides content protected by DRM to the communication devices 406, 408. The rights issuer 404 issues a license and an encryption/decryption key for the content. A communication device 406, 408 may receive the content directly from the content provider 402 or from another communication device, but preferably receives a license only from the rights issuer 404.

In accordance with the present invention, the content provider 402 provides the content along with a super-distribution right. Therefore, the communication devices 406, 408 receive the content from the content provider 402, and may thereafter forward the content to another communication device. In addition, the content is encrypted and decrypted with an encryption/decryption key issued by the rights issuer 404. The source communication device 406 may transmit the content to two or more destination communication devices 408 simultaneously.

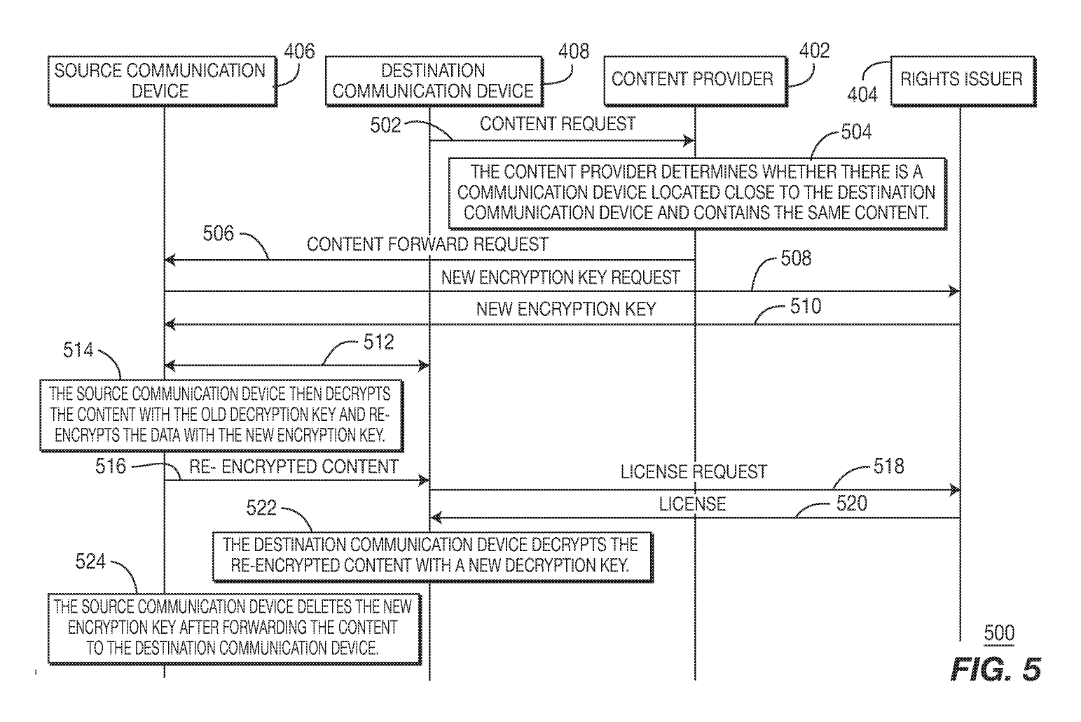

FIG. 5 is a signaling diagram of a process 500 for distributing data in accordance with the present invention. A user of the destination communication device 408 selects content the user wants to download and sends a content request to the content provider 402 to download the content (step 502). The content provider 402 determines whether there is a source communication device located close to the destination communication device 408 which contains the desired content (step 504).

The content provider 402 maintains a list of communication device identifications whose users agree with participation of distribution of the content in accordance with the present invention. The users of the communication devices may or may not agree with participating in the distribution due to privacy or other issues. The content provider 402, (or operator or the rights issuer), may ask the user of the communication devices at subscription or any other relevant time, if the user is interested in participating in such distribution. If the user agrees, the identification of the participating communication devices is added to the list. The user may be given benefits for the participation. Alternatively, the user may be provided with a capability of selectively activating and deactivating the function on his/her communication device at any time.

The content provider 402 also keeps a list of the content available on each of the participating communication devices 406, 408. The list should be updated up-to-date. The list is updated every time a participating communication devices 406, 408 downloads new content from the content provider 402. The participating communication devices 406, 408 may send an updated list to the content provider 402 each time the communication devices 406, 408 download new content or deletes any content. The communication devices 406, 408 may send an updated list of the content periodically or each time the organized distribution function is activated.

If at least one source communication device 406 is found at step 504, the content provider 402 sends a content forward request to the source communication device 406 to send the content to the destination communication device 408 (step 506). The content provider 402 may locate the source communication device 406 using any conventional positioning methods, such as GPS, triangulation of signals, or information regarding the cell with which the communication devices 406, 408 are associated.

Upon receipt of the content forward request, the source communication device 406 sends a request for a new encryption key to the rights issuer 404 and obtains a new encryption key from the rights issuer 404 (steps 508, 510). The source communication device 406 then establishes a connection with the destination communication device 408 (step 512).

The source communication device 406 then decrypts the content, (which is originally encrypted with an old encryption key), with an old decryption key and re-encrypts the data with the new encryption key (step 514). The source communication device 406 sends the re-encrypted content to the destination communication device 408 (step 516). The destination communication device 408 sends a license request to the rights issuer 404 and obtains a license from the rights issuer 404 (steps 518, 520). The re-encrypted content downloaded to the destination communication device 408 has to be decrypted with the same symmetric key that matches to the one used by the source communication device 406. This decryption key is included in the license provided by the rights issuer 404. The destination communication device 408 decrypts the re-encrypted content with a new decryption key (step 522). The source communication device 406 deletes the new encryption key after forwarding the content to the destination communication device 408 (step 524).

In accordance with the second embodiment of the present invention, the download of the content is faster and the load of the content provider 402 for forwarding the same content to multiple communication devices is reduced. Moreover, security and privacy issues raised by the new distribution from the source communication device 406 are resolved by re-encrypting the content with a new encryption key.

In a conventional system, as the same piece of encrypted content is duplicated many times, the risk of having a pair of encrypted content and symmetric key stolen increases. This risk is even amplified as the content may be duplicated to unknown users, not just to their friends or family members. In accordance with the present invention, this risk is reduced since the source communication device 406 uses a new encryption key for re-encrypting the content before forwarding it.

The content provider 402 checks a load of the source communication devices 406 such that no communication device is overloaded with content forwarding. For this purpose, the content provider 402 may keep an updated list of the number of content forwarding requests per participating communication device, and should not request a participating communication device to forward the content more than a maximum number of simultaneous requests.

All the transactions regarding selection of the nearest source communication device 406, transmission of the request from the content provider 402 to the source communication device 406 to forward the content, re-encryption of the content, notification of a deletion of content or an updated list of content are performed transparent to the users.

FIG. 6 is a block diagram of a communication device 600, (i.e., the source communication device 406 and the destination communication device 408), used in the system 400. The communication device 600 comprises an encryption/decryption unit 602 and a communication unit 604. The encryption/decryption unit 602 decrypts the data with a decryption key and encrypts the data with an encryption key. The communication unit 604 sends data to the other communication devices.

The encryption/decryption unit of the source communication device 406 decrypts data with an old decryption key and re-encrypts the decrypted data with a new encryption key received from the rights issuer. The communication unit of the source communication device 406 then sends the re-encrypted data to the destination communication device 408 in accordance with the request from the content provider 402. The communication unit of the destination communication device 408 receives the re-encrypted data from the source communication device 406. The encryption/decryption unit of the destination communication device 408 decrypts the re-encrypted data with a decryption key received from the rights issuer 404.

The cooperative distribution of the first embodiment may be implemented along with the second embodiment so that DRM is enforced during the cooperative distribution. In such case, the content provider 402 may have a functionality of the central tracker 204, and the communication device 600 may include the handover unit 304 and/or the positioning unit 306.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication including a plurality of communication devices and a central tracker, a method for distributing data to the communication devices, the method comprising:
the central tracker receiving a request for downloading of data from a plurality of communication devices;
each of the communication devices establishing a connection to a seeder and a connection to other communication devices that requested the same data;
the seeder sending a different piece of the data to each of the communication devices; and
the communication devices sending the received piece of the data to other communication devices using the connection established between them;
wherein each of the communication devices automatically suspends and resumes downloading of a piece of the data from other communication devices when one of said plurality of communication devices performs a handover.

2. The method of claim 1 wherein the connection between the communication devices is established via one of a wireless local area network (WLAN) and a wide area cellular network.

3. The method of claim 2 wherein the communication devices obtain location information of other communication devices and establishes the connection to other communication devices based on the location information.

4. The method of claim 3 wherein the communication devices obtain the location information using at least one of a global positioning system (GPS), a triangulation method and information regarding a cell with which the first and second communication devices are associated.

5. The method of claim 3 wherein the location information is provided by the central tracker.

6. The method of claim 2 wherein the communication devices perform an inter-technology handover between the wide area cellular network and the WLAN.

7. In a wireless communication including a content provider, a rights issuer and a plurality of communication devices, a method for distributing data to a communication device, the method comprising:
at least one destination communication device requesting download of data from the content provider;
the content provider identifying a source communication device which possesses the data;
the content provider requesting the source communication device to forward the data to the destination communication device;
the destination communication device and the source communication device establishing a link between them;
the source communication device receiving a new encryption key from the rights issuer;
the source communication device decrypting the data with an old decryption key that the source communication device received previously for the data;
the source communication device re-encrypting the data with the new encryption key;
the source communication device forwarding the re-encrypted data to the destination communication device via the link; and
the destination communication device obtaining a license and a decryption key from the rights issuer and decrypting the re-encrypted data with the decryption key.

8. The method of claim 7 wherein the content provider identifies the source communication device that is located close to the destination communication device.

9. The method of claim 8 wherein the content provider identifies the source communication device using one of a global positioning system (GPS), a triangulation method and information regarding a cell in which the source and destination communication devices are located.

10. The method of claim 8 wherein the link between the source communication device and the destination communication device is a peer-to-peer link.

11. The method of claim 7 wherein the content provider maintains a list of communication device identifications whose users agree with participation of distribution of the content in accordance with the request of the content provider.

12. The method of claim 11 wherein a user of the communication device has a capability of selectively activating and deactivating a function for distribution.

13. The method of claim 7 wherein each of the communication devices sends an updated list of contents that each communication device possesses to the content provider.

14. The method of claim 7 wherein the content provider checking a load of the source communication device such that the source communication device is not overloaded for forwarding the data.

15. A wireless communication system for distributing data to a communication device, the system comprising:
a plurality of communication devices;
a central tracker configured to receive a request for downloading of data from the communication devices;
a seeder configured to send a different piece of the data to each of the communication devices; and
each of the communication devices comprising:
a communication unit configured to establish a connection to the seeder and a connection to other communication devices that requested the same data, send a received piece of the data to other communication devices using the connection established between the communication devices; and
a handover unit configured to perform a handover, wherein the communication unit automatically suspends and resumes downloading of a piece of the data from other communication devices when a handover is performed.

16. The system of claim 15 wherein the connection between the communication devices is established via one of a wireless local area network (WLAN) and a wide area cellular network.

17. The system of claim 16 wherein each of the communication devices include a positioning unit to obtain location information of other communication devices, whereby the communication unit establishes the connection to other communication devices based on the location information.

18. The system of claim 17 wherein the positioning unit obtains the location information using at least one of a global positioning system (GPS), a triangulation method and information regarding a cell with which the communication devices are associated.

19. The system of claim 16 wherein each of the communication devices obtain the location information from the central tracker.

20. The system of claim 16 wherein the handover unit performs an inter-technology handover between the wide area cellular network and the WLAN.

21. The system of claim 15 wherein the seeder and the central tracker are the same entity.

22. The system of claim 15 wherein the central tracker is included in a service provider server.

23. The system of claim 15 wherein at least one of the communication devices is configured to perform functions of the central tracker and the seeder.

24. The system of claim 15 wherein at least one of the central tracker and the seeder is included in one of a base station and a radio network controller (RNC) of a radio access network.

25. A wireless communication system for distributing data to a communication device, the system comprising:
a content provider configured to identify a source communication device which possesses the data that is requested by a destination communication device and request the source communication device to forward the data to the destination communication device;
a rights issuer configured to issue a license and an encryption/decryption key for the data;
the source communication device comprising:
an encryption/decryption unit configured to decrypt the data with an old decryption key and re-encrypt the data with a new encryption key received from the rights issuer; and
a communication unit configured to send the re-encrypted data to the destination communication device in accordance with the request from the content provider; and
the destination communication device comprising:
a communication unit configured to receive the re-encrypted data from the source communication device; and
an encryption/decryption unit configured to decrypt the re-encrypted data with a decryption key received from the rights issuer.

26. The system of claim 25 wherein the content provider identifies the source communication device that is located close to the destination communication device.

27. The system of claim 26 wherein the content provider identifies the source communication device using one of a global positioning system (GPS), a triangulation method and information regarding a cell in which the source communication device and the destination communication device are located.

28. The system of claim 26 wherein the source communication device and the destination communication device establishes a link via one of a wide area cellular network and a wireless local area network (WLAN).

29. The system of claim 25 wherein the content provider maintains a list of communication device identifications whose users agree with participation of distribution of the content in accordance with the request of the content provider.

30. The system of claim 29 wherein a user of the communication device has a capability of selectively activating and deactivating a function for distribution.

31. The system of claim 25 wherein a communication device sends an updated list of contents that each communication device possesses to the content provider.

32. The system of claim 25 wherein the content provider checks a load of the source communication device such that the source communication is not overloaded for forwarding the data.
